(19) United States
(12) Patent Application Publication
(10) Pub. No.: US 2026/0278494 A1
(43) Pub. Date: Sep. 17, 2026

(54) Mission-Based Agent Generation System for Adaptive AI Tasks

(71) Applicant: Gennaro Anthony Cuomo, Raleigh, NC (US)

(72) Inventor: Gennaro Anthony Cuomo, Raleigh, NC (US)

(21) Appl. No.: 19/198,061

(22) Filed: May 4, 2025

Related U.S. Application Data
(60) Provisional application No. 63/769,970, filed on Mar. 11, 2025.

(51) Int. Cl. G06Q 10/0631

(52) U.S. Cl. CPC G06Q 10/063112; G06Q 10/06316

(57) ABSTRACT

A system and method are disclosed for dynamically generating and orchestrating a team of AI agents in response to a high-level execution objective expressed in natural language. The system includes an agent proposal module that uses a language model to decompose the objective into specialized agent roles, each with defined input/output behavior, tool access, and optional scoring logic. An execution orchestrator coordinates agent operation across pre-processing, core, and post-processing stages, while a shared state memory stores all inputs, intermediate results, and final outputs with full traceability. A reflection module and optional human-in-the-loop interface enable review, scoring, and mission replanning based on system or user feedback. The invention supports applications such as document drafting, compliance evaluation, structured comparison, interview simulation, and educational content generation. It enables auditable, low-configuration task execution that produces high-quality outputs with minimal setup, supporting scalable refinement through transparent orchestration, reusable memory structures, and reviewer-guided feedback cycles.

### CROSS-REFERENCE TO RELATED APPLICATIONS:

This application claims the benefit of priority under 35 U.S.C. § 119(e) to U.S. Provisional Patent Application No. 63/769,970, filed on Mar. 11, 2025, titled “Reflective Multi-Agent AI System with Human-Guided Adaptation”, the entire contents of which are hereby incorporated by reference.

### BACKGROUND

### Field of the Invention

The present invention relates to multi-agent artificial intelligence (AI) systems for automating complex workflows and task-oriented processes. It is particularly relevant to AI frameworks that coordinate collaborative agents to generate structured outcomes across diverse domains.

### Description of the Related Art

Multi-agent artificial intelligence (AI) systems have become an increasingly common architecture for automating complex tasks. These systems typically consist of multiple agents, each assigned a predefined role, working together to perform specialized components of a larger objective. Advances in this area have enabled agent coordination across tasks such as research synthesis, document generation, compliance analysis, and question answering.

Recent frameworks have introduced various orchestration models, including role-based agent teams, graph-based execution flows, and conversational multi-agent environments. These approaches allow agents to communicate, share intermediate results, and perform collaborative reasoning. Many support persistence, external tool integration, and step-wise task decomposition. However, despite these improvements, several core limitations remain.

Existing systems generally require developers to define agent roles, prompts, and execution logic manually, often tailoring each workflow to a specific use case. When a new objective arises—such as analyzing a novel document type or generating responses for unfamiliar subject matter—the system must be reconfigured to include additional agents or adapt bespoke logic paths. This manual intervention reduces reuse and inhibits scalability, as significant developer effort is required to achieve successful outputs across diverse tasks. The lack of generalized decomposition mechanisms and dynamic agent synthesis limits the applicability of such systems in open-ended or rapidly evolving domains.

Furthermore, while some emerging systems allow for dynamic instantiation of agents, they often do so at the expense of traceability. When roles are generated on-the-fly, it becomes more difficult to preserve provenance, validate task-specific decisions, or reconstruct the reasoning pathway of a given agent. This creates challenges in auditing outputs, particularly in high-stakes domains where transparency and reproducibility are essential.

Accordingly, there remains a need for a system that can generate, configure, and orchestrate agents dynamically in response to high-level mission goals and contextual task vectors, while preserving sufficient structure to support traceable, auditable execution workflows.

### Comparison to Related Art

Prior developments in multi-agent AI systems and orchestration frameworks have made significant progress in enabling collaboration across distributed, role-based agents. However, several core limitations persist, including rigid agent definitions, lack of mission-specific dynamic decomposition, and absence of persistent, auditable shared state for traceability.

U.S. Patent Application No. 20230367619 describes a system for bootstrapping dynamic orchestration workflows for stateful automation tasks. While it supports automated generation of execution plans and reuse of trace data, it does not disclose agent teams dynamically generated from semantic task decomposition, nor does it include LLM-based role synthesis, multi-tier execution sequencing, or traceable human-in-the-loop refinement cycles.

U.S. Patent Application No. 20230195847 discloses a system for human-augmented artificial intelligence configuration, integrating feedback from human reviewers in workflows to improve AI performance. While it introduces adjustable AI pipelines with feedback sensitivity, it does not support dynamic mission restructuring, automated agent regeneration, or persistent memory with complete execution traceability.

WO2021084510A1 outlines a generalized framework for executing artificial intelligence agents within a modular operating environment. It provides flexibility for chaining models and defining workflows, and it supports confidence-based agent execution. However, the architecture depends on user-defined static workflows and does not feature automated instantiation of agents from natural language mission prompts, nor a structured shared memory layer for persistent execution tracking.

Shu et al. (“Towards Effective GenAI Multi-Agent Collaboration: Design and Evaluation for Enterprise Applications,” arXiv, 2024) examine LLM-powered multi-agent systems and evaluate routing and coordination strategies across enterprise tasks. While they demonstrate the value of agent collaboration and inter-agent referencing, the agents are assumed to be predefined. The system lacks dynamic agent role generation, a structured mission objective interface, or reusable execution state.

Collectively, these references contribute to the advancement of AI orchestration, agent collaboration, and feedback integration. However, they fall short of offering a cohesive architecture that dynamically generates role-specific agents from a structured mission, coordinates execution through a multi-tiered orchestration engine, and preserves transparency through a persistent shared state. The present invention addresses these gaps with a novel, modular framework that supports task-driven AI mission execution with integrated reflection, traceability, and adaptive human oversight.

### SUMMARY OF THE INVENTION

The present invention provides a system and method for dynamically generating and orchestrating multi-agent teams in response to a high-level execution objective expressed in natural language, such as a mission statement and accompanying task vector. This objective specifies both the overall intent and the subtask decomposition that informs agent specialization. Rather than relying on static workflows or broad, pre-defined agent roles, the system interprets this directive to propose and instantiate a set of purpose-specific agents, each with clearly scoped responsibilities aligned to the mission's semantic structure.

Each agent is instantiated with structured task instructions, defined input-output expectations, and optional tool integrations such as web search, file access, language model querying, or retrieval-augmented generation (RAG) tools for contextual grounding. These agents are organized into a coordinated pipeline that may include pre-processing agents for data gathering and preparation, core agents for semantic reasoning or content generation, and post-processing agents for formatting, synthesis, or quality control. The architecture supports tiered execution sequencing and agent-to-agent context sharing through a centralized shared state memory.

This architecture achieves high output efficiency relative to configuration effort: with minimal system customization, the invention can produce complex, high-quality results while maintaining a compact operational footprint—a characteristic we refer to as a favorable code-to-outcome ratio. By employing narrowly scoped, role-specific agents instead of broad, generalized ones, the system conforms to large language model (LLM) best practices—namely, that precise, context-aware instructions improve both the quality and controllability of generated content.

To ensure transparency and reproducibility, the system maintains an execution memory that captures agent provenance, prompts, intermediate results, and refinement history. This enables end-to-end traceability, allowing users to audit, revise, and extend outputs with full visibility into agent behavior—even when the agents are generated dynamically. A reflection agent and optional human-in-the-loop reviewer may be engaged to evaluate output quality, triggering replanning or re-execution cycles using updated inputs or reviewer feedback.

The invention is broadly applicable across domains that require structured AI-assisted analysis and content generation. Example applications include compliance evaluation, comparative policy analysis, academic or technical document generation, structured interview response synthesis, and human-guided AI review workflows in regulated environments. These use cases benefit from the system's favorable code-to-outcome ratio, iterative adaptability, and reusable memory structure, which together support scalable mission refinement across diverse, dynamic task domains.

### BRIEF DESCRIPTION OF THE DRAWINGS

FIG. 1 illustrates a system architecture comprising mission definition, agent generation, orchestration, shared memory, and human-in-the-loop feedback.

FIG. 2 illustrates a high-level execution objective expressed as a natural language mission statement, along with its corresponding structured task vector, which segments the objective into discrete subtasks for academic paper generation.

FIG. 3 depicts the agent execution pipeline, including pre-, core-, and post-processing phases, and their interaction with memory and output modules.

FIG. 4 presents the shared state memory model along with an illustrative directory structure for storing execution artifacts, references, and logs. The example shown corresponds to a compliance policy use case.

FIG. 5 outlines the mission feedback and refinement loop, including post-execution review, optional human input, and regeneration of agent teams.

FIG. 6 provides a sample output table comparing the supplier codes of conduct from Amazon and UPS across multiple compliance areas, illustrating the system's ability to perform structured analysis and compute similarity scores between policy documents.

### DETAILED DESCRIPTION OF THE INVENTION

### System Overview

The present invention relates to systems and methods for dynamically generating and orchestrating teams of AI agents in response to high-level task descriptions. The architecture enables automated execution of complex, context-sensitive missions by interpreting structured goals, proposing role-specific agents, coordinating execution, and managing shared memory and review feedback.

Unlike traditional static pipelines, this system dynamically generates agents in response to mission semantics and task decomposition, allowing for scalable adaptation while preserving traceability and supporting optional human oversight. This dynamic construction and execution model results in a favorable code-to-outcome ratio, enabling the system to produce high-quality outputs with compact configuration effort. The architecture is designed to complement existing agent frameworks by providing a modular extension for dynamic mission planning and traceable execution.

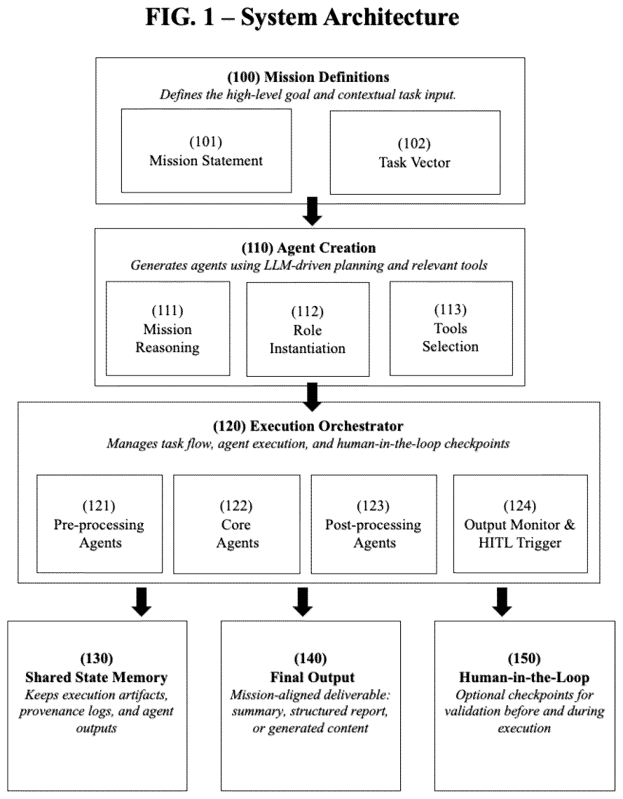

Referring to FIG. 1, the architecture comprises three primary stages: Mission Definition (100), Agent Creation (110), and Execution Orchestration (120). The Mission Definition stage receives two structured inputs: a Mission Statement (101), expressed in natural language, describing the overarching task objective; and a Task Vector (102), a structured list of categories, subtopics, or checkpoints that segment the mission into discrete, actionable components. These inputs jointly form the basis for downstream agent planning and execution control.

The Agent Creation stage interprets the mission inputs using a large language model (LLM) to perform semantic decomposition and role assignment. The Agent Proposal Module generates a team of agents, each assigned a distinct functional scope based on one or more task vector entries. For each agent, the system defines input/output expectations, relevant prompts, tool assignments, and optional scoring criteria. The resulting configuration is passed to the Execution Orchestrator (120), which sequences the agents across three execution tiers: Pre-processing, Core, and Post-processing. The orchestrator evaluates dependencies, tracks agent readiness, and can initiate Human-in-the-Loop (HITL) review checkpoints where quality confidence is low or human validation is required.

As agents perform their respective tasks, all outputs, logs, and intermediate artifacts are written to a centralized Shared State Memory (130). This memory structure allows agents to read from and write to common data references and preserves full provenance of the execution lifecycle. At the end of execution, a Final Output (140)—such as a report, structured document, or formatted summary—is generated. Post-run review and revision may be initiated via the HITL interface (150), enabling iterative refinement based on automated or human evaluation.

### Mission Specification and Task Vector Decomposition

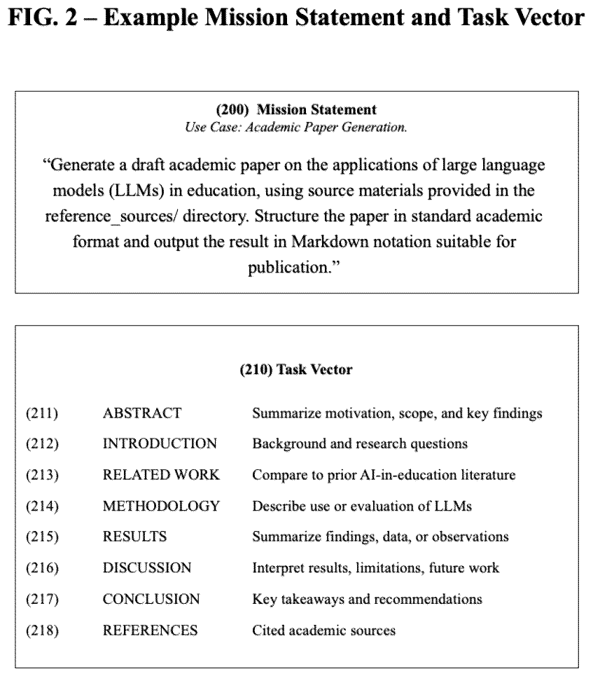

FIG. 2 depicts an example input configuration used to define a high-level execution objective. This objective consists of two components: a Mission Statement (200), expressed in natural language, and a corresponding Task Vector (210), which segments the mission into structured subtasks. The Mission Statement defines the intended purpose, scope, and output characteristics. For example, a user may specify the generation of an academic article on the impact of large language models in education, along with an expected output format such as Markdown. This specification informs the system's inference of tone, structure, and audience expectations.

The Task Vector complements the mission by providing a granular decomposition of the content. In the academic article case, this includes entries such as Abstract (211), Introduction (212), Related Work (213), Methodology (214), Results (215), and Conclusion (216). In other domains, task vector elements may correspond to compliance topics, interview segments, structured evaluation criteria, or processing checkpoints. Each task vector entry acts as a semantic anchor for agent instantiation and coordination.

Together, the mission and task vector form a structured input directive—referred to as the input contract—that the Agent Proposal Module uses to construct a dynamic execution plan. This module leverages a large language model (LLM) to perform semantic decomposition and assign task vector elements to narrowly scoped agent roles. Agent configurations are generated without reliance on static workflows or fixed templates, reflecting the system's minimal configuration requirements. As part of this process, the module may also define inter-agent dependencies by specifying which artifacts—such as named files or structured outputs—should be passed as contextual input to downstream agents, seeding collaboration and maintaining continuity of reasoning across the execution graph.

This minimal input requirement—just a mission and task vector—embodies the system's favorable code-to-outcome ratio, allowing diverse, high-quality outputs to be produced with reduced configuration effort.

### Agent Execution Pipeline

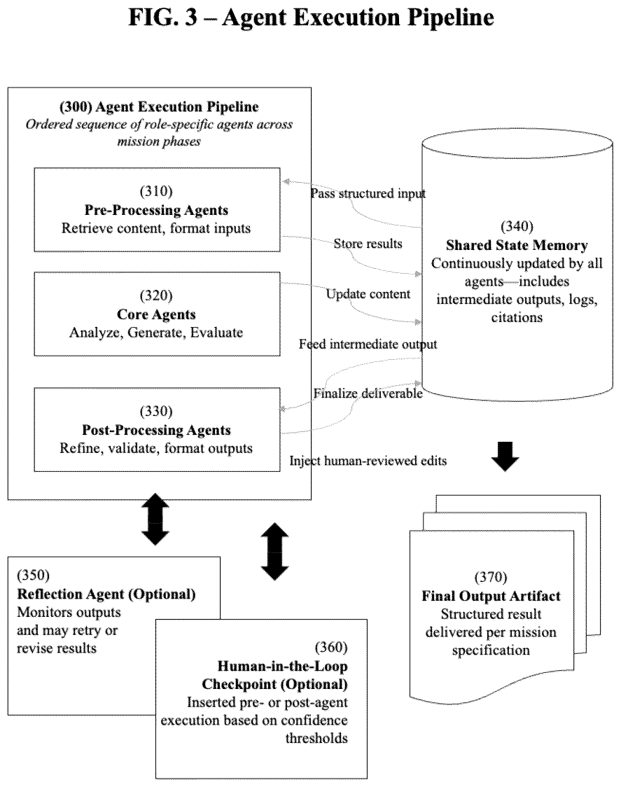

FIG. 3 illustrates the runtime structure of the execution pipeline. Once agent roles have been generated, the Execution Orchestrator manages their scheduling and lifecycle coordination. Agents are grouped into functional tiers based on their operational role: Pre-Processing Agents (310), Core Agents (320), and Post-Processing Agents (330).

Pre-Processing Agents prepare the operational context for downstream processing. Tasks may include document ingestion, file normalization, metadata extraction, or conversion of unstructured data into structured intermediate representations (e.g., chunked paragraphs or prompt-ready lists). In a compliance use case, a pre-processing agent might extract policy segments by topic and apply consistent formatting conventions.

Core Agents handle the main analysis or synthesis work aligned to task vector elements. Each core agent is assigned one or more vector entries, and its behavior is shaped by the semantic intent and structural boundaries defined in the task vector. These agents perform their functions using LLM prompts tailored to their assigned roles and operate over bounded scopes. They interface with the Shared State Memory (340), which serves as both a coordination layer and a persistent execution log—allowing outputs from one agent to be retrieved and used as inputs by others.

For example, a core agent tasked with analyzing “Child Labor” policy language may compare passages against a rubric and record findings with associated confidence scores and citations. In another example, for an academic article generation mission, a core agent may be assigned to handle references—retrieving relevant sources, validating their credibility, and formatting citations for inclusion in the final output.

Post-Processing Agents consolidate and polish outputs produced by earlier stages. Their functions may include template rendering, table merging, report formatting, or stylistic normalization. These agents are especially relevant in output-sensitive domains, such as academic publishing, regulatory reporting, or formal evaluation contexts.

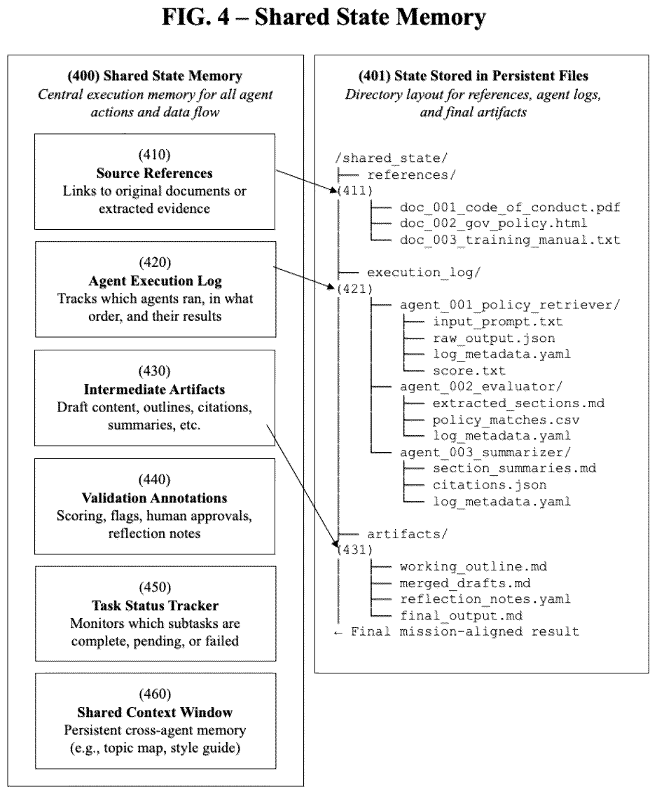

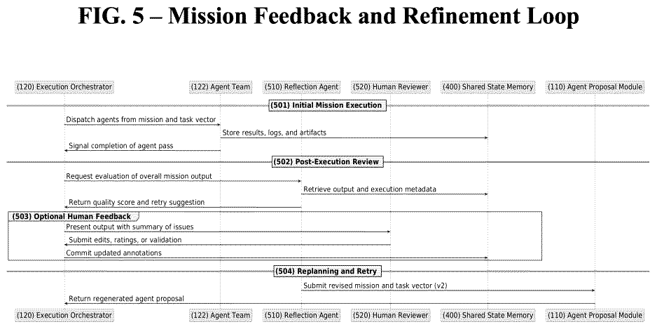

Optionally, the pipeline may include a Reflection Agent (350) and a Human-in-the-Loop Interface (360). These components engage after core processing is complete and provide system-level review of results. The Reflection Agent uses heuristic rules or LLM-based scoring to assess coherence, coverage, and goal alignment. The HITL interface may be triggered automatically or configured for mandatory review in sensitive workflows. Both systems contribute evaluation data to the Shared State, enabling versioning and traceability of corrective actions. FIGS. 4 and 5 describe the internal structure of shared state and the review-refinement loop in greater detail.

### Shared State Memory and Persistent Store Traceability

FIG. 4 illustrates one embodiment of the Shared State Memory (400), a centralized data layer that enables coordination, traceability, and post-execution audit across all agent activities. This memory layer is accessible to agents throughout execution and is responsible for recording all task inputs, intermediate artifacts, runtime metadata, and final outputs. The shared state is designed to support temporal traceability and structural access, enabling the system to reconstruct decisions, validate reasoning pathways, and persist artifacts across execution cycles.

In the illustrated embodiment, the shared state is organized using a directory-style file structure (410), though the system is not limited to this implementation. Equivalent configurations may use document stores, relational databases, key-value architectures, or cloud-native storage systems. The essential requirement is that the persistence model supports transparent association between agent outputs, execution events, and contextual references.

The example layout includes three main subdivisions:
(411) references/—Stores source materials consumed by agents during execution. This may include uploaded documents, scraped web content, citations, or cached API responses. Each item is tagged with a timestamp, unique identifier, and relevance metadata for later use or citation.
(421) execution_log/—Captures detailed trace records for each agent, including input parameters, prompt configurations, LLM responses, internal scoring outputs, and timestamped results. Each log entry is optionally tagged with the originating agent's identity, version, and assigned task vector item. This log enables full reconstruction of each agent's reasoning flow and can be used for debugging, audit validation, compliance assurance, or version tracking. In many cases, artifacts generated by one agent serve as structured inputs for downstream agents, preserving context continuity and enabling progressive refinement across the execution pipeline.
(431) artifacts/—Contains intermediate deliverables and final outputs generated during the mission. Examples include coverage tables, narrative summaries, similarity matrices, structured reports, or output files rendered in formats such as Markdown, JSON, or HTML. These artifacts may also be cross-referenced to the originating agent and task vector entry, supporting chain-of-custody analysis and facilitating rollback or incremental revision workflows.

This shared memory layout ensures that all mission artifacts—whether generated autonomously or edited via human intervention—are persistently stored and logically accessible. The structure also enables missions to be revisited, replayed, or forked with full historical context, supporting iterative development, regulatory audit readiness, and downstream reproducibility in sensitive domains such as compliance analysis, legal review, or controlled research synthesis.

### Mission Review and Refinement Loop

FIG. 5 illustrates the Mission Feedback and Refinement Loop, a system process for post-execution quality evaluation and iterative improvement. This loop allows the architecture to incorporate both automated reflection and optional human oversight, especially in domains where interpretability, correctness, or regulatory alignment is essential.

In the Initial Mission Execution phase (501), the Execution Orchestrator (120) dispatches the Agent Team (122) based on the configuration generated by the Agent Proposal Module (110). Each agent performs its assigned function and logs outputs, citations, metrics, and results to the Shared State Memory (400). Upon completion, the orchestrator records completion metadata and transitions the system into a review phase.

In the Post-Execution Review phase (502), the Reflection Agent (510) is engaged to evaluate the quality, coherence, and completeness of the generated outputs. This agent may use LLM-based critique prompts, structural validators, or scoring templates tailored to the mission's domain. In certain embodiments, the reflection process operates in multiple tiers, beginning with individual agent-level self-assessments, followed by holistic team-level evaluation, and culminating in system-level scoring or decision triggers. Based on the findings, the system determines whether a refinement loop is warranted.

If additional feedback is needed, the system enters the Optional Human Feedback phase (503). In this stage, the system presents structured summaries, flagged issues, or editable excerpts to a Human Reviewer (520). The interface may support ranked scoring, direct annotation, or guided response fields. In some implementations, the Human Reviewer is abstracted as a Human Agent integrated into the orchestration cycle, enabling structured interaction alongside other agents while maintaining auditability and task continuity. Feedback is committed to the shared state and may serve as input to subsequent execution cycles.

In the Replanning and Retry phase (504), the Reflection Agent or Human Reviewer submits a revised version of the mission statement or task vector to the Agent Proposal Module. This revised input often narrows the scope, adjusts tone, or introduces clarification to ambiguous components. A new team of agents is generated, and the orchestrator launches a second execution cycle under the updated configuration.

This feedback loop is modular and repeatable, allowing the system to evolve outputs through structured correction and reinforcement without requiring changes to core system logic. Review and replanning steps are fully traceable in the shared memory layer, ensuring reproducibility and system accountability throughout iterative runs.

### Use Case—Compliance Similarity Report

One representative application of the present invention is automated comparison of corporate policy documents against a standardized compliance framework. In this use case, the system is tasked with evaluating the degree of alignment between the supplier codes of conduct issued by two organizations—such as Amazon and UPS—across a defined set of policy disciplines.

To accomplish this, the system accepts a mission statement specifying the comparison objective and a task vector enumerating the compliance categories to be assessed (for instance, “Child Labor,” “Environmental Protection,” or “Anti-Bribery and Anti-Corruption”). It then dynamically generates a team of agents, each assigned to retrieve and analyze text relevant to a specific category. Agents compare semantic and structural content, log findings, and record similarity scores and citations to shared state.

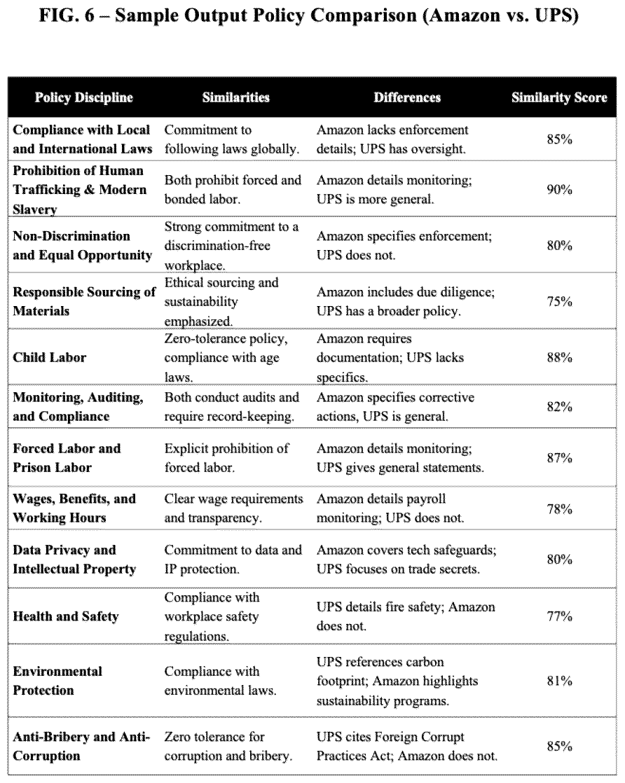

FIG. 6 shows a representative output: a tabular similarity report that includes observed similarities, noted differences, and a percentage-based similarity score for each policy area. The output may be delivered as a Markdown file or spreadsheet and reviewed or extended in a follow-on cycle. This example demonstrates the system's ability to support audit-ready, interpretable deliverables with minimal manual intervention.

The embodiments described herein are illustrative and not limiting. Variations in implementation—including alternative memory structures, agent instantiation mechanisms, reasoning engines, tool configurations, or feedback workflows—may be employed without departing from the scope of the invention. The system may be realized in software, hardware, or hybrid environments and is compatible with a wide range of mission-driven applications.

The architecture supports modular decomposition of high-level execution objectives into executable agent plans, dynamically scoped to structured task representations—such as task vectors—and the operational context. Unlike fixed agent pipelines or manually constructed workflows, the system enables on-demand instantiation of role-specific agents based on semantic interpretation of the input directive, coordinated through a flexible orchestration engine. Agent reasoning may be driven by large language models or other domain-specific semantic processors, while all execution is persistently logged to support full traceability of actions, dependencies, and outcomes.

This design allows structured, high-quality outputs to be generated with minimal configuration effort, reflecting a favorable code-to-outcome ratio that reduces the need for manual intervention while preserving auditability and adaptability across use cases such as document drafting, compliance evaluation, and knowledge synthesis.

### Definition of Terms

Code-to-Outcome Ratio: A measure of system efficiency reflecting the quality and completeness of outputs generated per unit of configuration or programming effort. A favorable code-to-outcome ratio implies high utility with minimal manual intervention, aligning with goals of low-friction automation and scalable AI orchestration.

Execution Objective—A high-level directive expressed in natural or structured language that specifies the intended outcome of a task. It serves as the basis for generating, coordinating, and evaluating role-specific AI agents within the system.

Mission Statement—A high-level natural language expression of the execution objective. It serves as the semantic anchor from which the system interprets intent, derives agent roles, and determines output structure and scope.

Task Vector—A structured decomposition of the execution objective into task-specific elements—such as topics, categories, or workflow components. It provides the scaffolding for agent instantiation, role assignment, and sequencing during orchestration.

Agent—A software entity instantiated to perform a specific role within a mission. Each agent operates over a defined scope, executes prompt-based reasoning (typically powered by a large language model), and contributes to a shared output structure.

Agent Proposal Module—A subsystem that interprets the mission and task vector using LLM-powered decomposition and planning. It dynamically generates agent definitions, role assignments, and configuration instructions for each agent in the team.

Execution Orchestrator—A control mechanism responsible for scheduling and sequencing agent execution. It resolves dependencies, monitors task progress, handles retries or fallbacks, and coordinates the flow of data across agent tiers.

Execution Context—The combined set of data, artifacts, prompts, and prior outputs available to an agent at runtime. It governs input interpretation and enables inter-agent collaboration by preserving continuity across tasks and roles.

Shared State Memory—A centralized data layer that maintains agent inputs, intermediate results, logs, and final artifacts. It supports read/write access across agents and is typically persisted to file system, cloud storage, or equivalent traceable medium.

Reflection Agent—A specialized evaluation module that reviews completed outputs using scoring heuristics, rubrics, or prompt-based critique via LLMs. It can trigger replanning or submit results to human reviewers when confidence thresholds are unmet.

Human-in-the-Loop (HITL)—An optional review interface that allows a human to validate, correct, or provide feedback on intermediate or final outputs. The system may prompt the human with summaries, choices, or targeted clarifications and log responses for traceability.

Pre-Processing Agent—An agent tasked with preparing inputs before core analysis begins. Examples include document retrieval, formatting normalization, or extraction of structured data from unstructured sources.

Post-Processing Agent—An agent that refines outputs after core analysis is complete. Typical responsibilities include formatting final reports, summarizing results, and applying consistency or compliance checks to match the desired output format.

Provenance Tracking—A system capability that records the full processing history of agent actions, including source inputs, decision paths, and output lineage. It enables reconstruction, debugging, and auditability of all generated artifacts.

Task Decomposition—The process of segmenting a mission into discrete, manageable components using the task vector. This decomposition is often inferred or assisted by a language model and directly informs agent specialization and modular execution.

What is claimed is:

1. A computer-implemented system for dynamic AI task execution, comprising:
a task directive input module configured to receive a structured task directive describing an execution objective;
an agent proposal module configured to generate a team of AI agents based on the task directive, wherein each agent has a role defined by functional scope and input-output behavior; and
an execution orchestrator configured to coordinate execution of the AI agents according to their assigned roles.

2. The system of claim 1, wherein the task directive comprises:
a mission statement in natural language describing a high-level objective, and
a task vector comprising a structured list of subtasks or thematic components.

3. The system of claim 1, further comprising a shared state memory accessible to the agents and the orchestrator, configured to store agent-generated outputs, source references, and execution metadata.

4. The system of claim 1, wherein the agent proposal module uses a large language model to perform semantic decomposition of the task directive for role generation.

5. The system of claim 1, wherein the AI agents are organized into a tiered execution sequence comprising pre-processing agents, core agents, and post-processing agents.

6. The system of claim 1, further comprising a reflection agent configured to evaluate the quality of agent outputs and initiate revision of the task directive.

7. The system of claim 6, further comprising a human review interface configured to receive reviewer feedback and update the task directive accordingly.

8. The system of claim 3, wherein the shared state memory logs agent prompts, responses, timestamps, and decision traces to support provenance tracking and reproducibility.

9. A computer-implemented method for dynamic task execution using AI agents, the method comprising:
receiving a task directive describing a high-level objective;
generating, based on the task directive, a set of AI agents with defined roles;
executing the AI agents according to their assigned roles;
storing agent outputs and execution metadata in a shared memory;
evaluating the quality of the outputs; and
revising the task directive and repeating execution based on the evaluation.

10. The method of claim 9, wherein the task directive comprises:
a mission statement in natural language, and
a task vector listing discrete subtasks or analysis topics.

11. The method of claim 9, wherein the agent roles are generated using semantic reasoning performed by a large language model.

12. The method of claim 9, wherein the shared memory persists inputs, intermediate artifacts, execution logs, and final outputs in a retrievable structure.

13. The method of claim 9, wherein the agents are executed in a multi-stage pipeline including pre-processing, core, and post-processing roles.

14. The method of claim 9, further comprising invoking a reflection agent to assess alignment between the outputs and the task directive.

15. The method of claim 14, further comprising incorporating human reviewer input to modify the task directive and initiate a new execution cycle.
